(19) United States
(12) Patent Application Publication
(10) Pub. No.: US 2007/0015859 A1
(43) Pub. Date: Jan. 18, 2007

(54) Polyester resin composition containing organic modified layered silicate

(75) Inventors: Hisato Nagase, Shizuoka-ken (JP); Tetsuya Yoshida, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/478,690

(22) Filed: Jul. 3, 2006

(30) Foreign Application Priority Data
Jul. 12, 2005 (JP) 2005-203090

(51) Int. Cl. C08K 9/04

(52) U.S. Cl. 524/445; 524/604

(57) ABSTRACT

The present invention provides a polyester resin composition containing an organic modified layered silicate and a thermoplastic polyester resin, wherein the organic modified layered silicate contains between layers of a swellable layered silicate a cationic compound represented by the following formula (1): 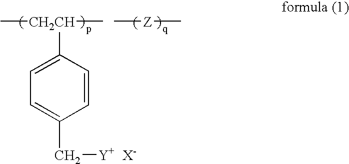
wherein X⁻ represents an anion; Y⁺ represents one group of atoms forming an ammonium cation, a phosphonium cation, and a nitrogen-containing heterocyclic compound cation; Z is at least one kind of unit derived from a monomer having an ethylenic double bond; p is 1 to 30 mol %; and q is 70 to 99 mol %.

### CROSS-REFERENCE TO RELATED APPLICATION

This application claims priority under 35 USC 119 from Japanese Patent Application No. 2005-203090, the disclosure of which is incorporated by reference herein.

### BACKGROUND OF THE INVENTION

1. Field of the Invention

The present invention relates to a polyester resin composition comprising a thermoplastic polyester resin and an organic modified layered silicate containing a cationic compound between the layers of a swellable layered silicate.

2. Description of the Related Art

Thermoplastic polyester resins as typified by polyethylene terephthalate (PET), polybutylene terephthalate (PBT), or polyethylene naphthalate (PEN) have excellent mechanical strength, heat resistance and molding processability, and therefore are used in a wide variety of applications such as moldings, films and fibers.

A variety of reinforced resin compositions are known in which reinforcing fibers, such as glass fibers and carbon fibers, or inorganic fillers, such as calcium carbonate, clay minerals and mica, are incorporated in these thermoplastic polyester resins and then kneaded, in order to promote further improvements in the mechanical strength (mechanical characteristics) and heat resistance. However, a problem introduced by these inorganic materials is that a sufficient improvement in the mechanical strength and heat resistance cannot be achieved since the materials are difficult to form fine particles and disperse uniformly by simple mixing and kneading. For example, Japanese Patent Application Laid-Open (JP-A) No. 6-56975 discloses a resin composition prepared by dispersing kaolin or talc into a PET-PEN copolymer resin, and this resin composition also encounters a similar problem. Particularly, when resistance to thermal decomposition is not sufficient, the polyester itself undergoes hydrolysis during high-temperature processing and fails to give moldings or films having substantially good appearance and physical properties. An attempt to add a large amount of the inorganic materials in order to further improve the mechanical strength and heat resistance results in an increase in specific gravity and deterioration in processability.

In recent years as a technique for solving the above problem, a variety of composite materials have been proposed which are improved in heat resistance and mechanical characteristics by dispersing a small amount of a layered silicate on a molecular level in a polyester resin. For example, JP-A No. 62-74957 discloses a composite material prepared by uniformly dispersing a lamellar clay mineral into a polyamide and having excellent strength, stiffness and heat resistance. Use of a small amount of the sheet clay mineral causes a significant improvement in the mechanical strength and heat resistance, but in the case of a polyester resin, a composite material in which the sheet clay mineral is uniformly dispersed cannot be obtained in the same way as can be with polyamide by the method disclosed in the above document. With relation to this technique, a further technique for improving dispersibility of the lamellar clay mineral with the aid of a compatibilizing agent is also disclosed. However, only moldings which have slightly improved mechanical strength and heat resistance, and have a large deterioration in toughness can be obtained (for example, see JP-A No. 3-62846).

Further, JP-A No. 8-53572 discloses a resin composition in which a layered silicate having an unreactive compound between the layers is dispersed in a polymer. However, when a polyester resin is used as a matrix resin, the polyester resin is succeptible to hydrolysis, because the resin is exposed to high temperatures during molding processing, and moldings and films having good appearance and physical properties cannot be obtained.

Furthermore, for example, JP-A No. 11-130951 discloses a polyester composite material containing a layered silicate organized with a phosphonium salt, stating that the mechanical strength and heat resistance can be improved. The composite material can be prevented from coloring due to the thermal decomposition of the organizing agent itself to maintain a good color tone and simultaneously can be somewhat improved in mechanical strength and heat resistance. However, since the presence of an organic cation of the organizing agent promotes the hydrolysis of the polyester resin at high temperatures (in molding processing), the mechanical strength and heat resistance of the composite material deteriorates, resulting in failure to give usable moldings and films in practice.

JP-A No. 11-1605, for example, discloses that layered silicate can be highly dispersed in a polyester resin by making ionic bonds between the layers with an organic phosphonium ion to give moldings excellent in strength, stiffness and heat resistance. However, it is impossible to prevent such hydrolysis at high temperatures as described above. Moreover, compositions and resin films also have a problem with hydrolysis resistance at high temperatures (for example, see JP-A Nos. 2000-53847 and 2000-327805).

### SUMMARY OF THE INVENTION

The present invention has been made in view of the above circumstances and provides a polyester resin composition containing an organic modified layered silicate.

According to an aspect of the invention, there is provided a polyester resin composition comprising an organic modified layered silicate and a thermoplastic polyester resin, wherein the organic modified layered silicate contains between layers of a swellable layered silicate at least a cation of a cationic compound represented by the following formula (1):

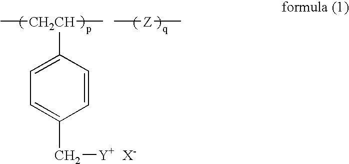

### DETAILED DESCRIPTION OF THE INVENTION

The inventors found that a polyester resin composition having high strength, heat resistance, high transparency with low haze, and dimensional stability can be obtained by using an organic modified layered silicate formed by inserting (intercalating) at least a cation of a cationic compound into between layers of a swellable layered silicate, and the invention was thereby completed.

Some embodiments of the invention are outlined below.

<1> A polyester resin composition comprising an organic modified layered silicate and a thermoplastic polyester resin, wherein the organic modified layered silicate containsbetween layers of a swellable layered silicate at least a cation of a cationic compound represented by the following formula (1): 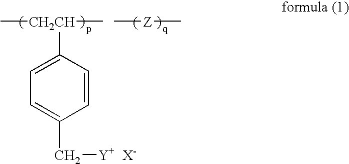
wherein X⁻ represents an anion; Y⁺ represents one group of atoms forming an ammonium cation, a phosphonium cation, or a nitrogen-containing heterocyclic compound cation; Z is at least one kind of unit derived from a monomer having an ethylenic double bond; p is 1 to 30 mol %; and q is 70 to 99 mol %.

<2> The polyester resin composition of the above-mentioned <1>, wherein the inorganic nature/organic nature ratio (I/O value) in an organic conceptual view of the above-mentioned Z in the above formula (1) is less than 0.8.

<3> The polyester resin composition of the above-mentioned <1> or <2>, wherein the above-mentioned Z in the above formula (1) is a polymer formed from at least one kind of monomer selected from the group consisting of alkyl (meth)acrylates, styrene and derivatives thereof.

<4> The polyester resin composition of the above-mentioned <1> or <2>, wherein the above formula (1) is represented by the following formula (2): 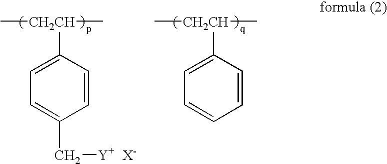
wherein X⁻ represents an anion; Y⁺ represents one group of atoms forming an ammonium cation, a phosphonium cation, or a nitrogen-containing heterocyclic compound cation; p is 1 to 30 mol %; and q is 70 to 99 mol %.

<5> The polyester resin composition of the above-mentioned <1> or <2>, wherein Y⁺ in the above formula (1) is a cation represented by one of the following formulae (3) to (5): 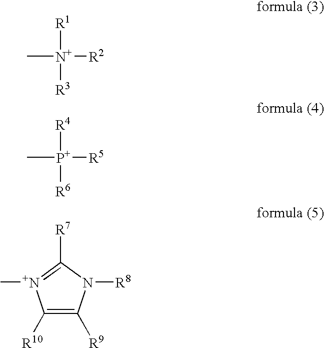
wherein R¹, R² and R³ independently represent a hydrogen atom, an alkyl group or an aryl group; R⁴, R⁵ and R⁶ independently represent an alkyl group or an aryl group; R⁷, R⁹ and R¹⁰ independently represent a hydrogen atom, a halogen atom, an alkyl group or an aryl group; and R⁸ represents an alkyl group or an aryl group.

<6> The polyester resin composition of the above-mentioned <1> or <2>, wherein the swellable layered silicate is one of synthetic hectorite, naturally occurring hectorite, naturally occurring montmorillonite, synthetic smectite or synthetic mica.

<7> The polyester resin composition of the above-mentioned <1> or <2>, wherein the content of the organic modified layered silicate is 0.5 to 30% by mass.

<8> The polyester resin composition of the above-mentioned <1> or <2>, wherein the thermoplastic polyester resin is polyethylene terephthalate.

<9> The polyester resin composition of the above-mentioned <1> or <2>, wherein the amount of the cationic compound contained between layers of the swellable layered silicate is 1.0 to 10.0 times the cation exchange capacity (CEC, meq/100 g) of the swellable layered silicate.

The polyester resin composition of the invention comprises an organic modified layered silicate and a thermoplastic polyester resin, wherein the organic modified layered silicate contains between layers of the swellable layered silicate at least a cation of a cationic compound represented by formula (1) below.

Hereinafter, the invention is described in detail.

(Cationic Compound)

The cationic compound used in the invention is represented by the following formula (1):

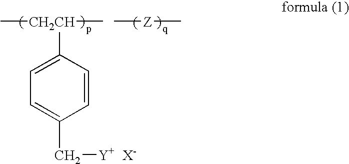

In formula (1), X⁻ represents an anion. This anion is not particularly limited and may be monovalent or multivalent (1/n·Xⁿ⁻ wherein n is an integer of 2 or more) and is preferably monovalent, or multivalent wherein n is 2 to 6. For example, X⁻ includes a halogen ion, p-toluenesulfonate ion, BF₄ ion, ClO₄ ion, PF₆ ion and NO₃ ion.

In formula (1), Y⁺ represents one group of atoms forming an ammonium cation, a phosphonium cation, or a nitrogen-containing heterocyclic compound cation.

The atomic group forming an ammonium cation, represented by Y⁺ in formula (1), is not particularly limited but is preferably represented by the following formula (3):

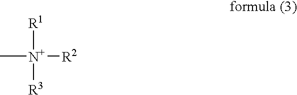

In the formula (3), R¹, R² and R³ independently represent a hydrogen atom, an alkyl group or an aryl group.

The alkyl group represented by R¹, R² or R³ in formula (3) is preferably an alkyl group containing 1 to 30 carbon atoms in total, more preferably an alkyl group containing 1 to 25 carbon atoms in total, still more preferably an alkyl group containing 1 to 20 carbon atoms. Preferable examples include a methyl group, ethyl group, n-propyl group, isopropyl group, n-butyl group, isobutyl group, tert-butyl group, n-hexyl group, n-octyl group, n-nonyl group, isononyl group, tert-nonyl group, cyclohexyl group, decyl group, dodecyl group, tetradecyl group, hexadecyl group, octadecyl group, 4-chlorobenzyl group, and (4-ethoxyphenyl)methyl group.

The alkyl group may further have a substituent group, and preferable examples of the substituent group include an alkyl group, aryl group, halogen atom, alkoxy group, aryloxy group, alkylthio group, arylthio group, alkoxycarbonyl group, aryloxycarbonyl group, alkoxycarbonylamino group, aryloxycarbonylamino group, acyloxy group, acylamino group, carbamoyl group, carbamoylamino group, sulfamoyl group, sulfamoylamino group, cyano group, carboxylate group, sulfonate group and heterocyclic group.

The aryl group represented by R¹, R² or R³ in formula (3) is preferably an aryl group containing 6 to 30 carbon atoms in total, more preferably an aryl group containing 6 to 25 carbon atoms in total, still more preferably an aryl group containing 6 to 20 carbon atoms. Preferable examples include a phenyl group, 4-methylphenyl group, 2-methylphenyl group, 4-methoxyphenyl group, naphthyl group, anthracenyl group and phenanthryl group.

The aryl group may further have a substituent group, and preferable examples of the substituent group include an alkyl group, aryl group, halogen atom, alkoxy group, aryloxy group, alkylthio group, arylthio group, alkoxycarbonyl group, aryloxycarbonyl group, alkoxycarbonylamino group, aryloxycarbonylamino group, acyloxy group, acylamino group, carbamoyl group, carbamoylamino group, sulfamoyl group, sulfamoylamino group, cyano group, carboxylate group, sulfonate group and heterocyclic group.

The atomic group forming a phosphonium cation, represented by Y⁺ in formula (1), is not particularly limited but is represented preferably by the following formula (4):

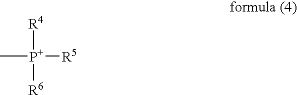

In formula (4), R⁴, R⁵ and R⁶ independently represent an alkyl group or an aryl group.

The alkyl group or aryl group represented by R⁴, R⁵ and R⁶ in formula (4) has the same meaning as defined in R¹, R² and R³ in formula (3), and preferable examples thereof are also the same as defined therein. R⁴, R⁵ and R⁶ may further have a substituent group, and the substituent group has the same meaning as defined in R¹, R² and R³, and preferable examples of the substituent group are also the same as defined therein.

The atomic group forming a nitrogen-containing heterocyclic compound cation, represented by Y⁺ in formula (1), is not particularly limited, but is preferably an atomic group obtained by quaternarizing a nitrogen atom constituting a heterocycle. Although the number of elements forming the heterocycle is not particularly limited, the heterocycle is preferably a 4- to 10-memberred ring, more preferably a 5- to 8-memberred ring. The heterocycle may be saturated or unsaturated, may be condensed and may have aromaticity. The heterocycle may contain oxygen and sulfur atoms in addition to the nitrogen and carbon atoms.

The nitrogen-containing 6-memberred aromatic compound that can be used in the invention includes, for example, pyridine, 2-picoline, 3-picoline, 4-picoline, 2,3-lutidine, 2,4-lutidine, 2,5-lutidine, 2,6-lutidine, 3,5-lutidine, 2,4,6-collidine etc., and is preferably a nitrogen-containing aromatic compound unsubstituted at the position 1. Particularly pyridine and 4-picoline are preferable.

The nitrogen-containing 5-memberred aromatic compound or nitrogen-containing condensed heterocycle that can be used in the invention includes, for example, pyrrole, pyrazole, imidazole, triazole, tetrazole, isoxazole, oxazole, thiazole, indole, isoindole, indazole, 1H-indazole, benzimidazole, benzotriazole, benzisoxazole, benzoxazole, benzothiazole, carbazole, quinoline, isoquinoline, phenanthridine, acridine, 1,8-naphthalidine, quinoxaline, quinazoline, cinnoline, phthalazine, purine, phenoxazine, phenothiazine and phenazine, as well as derivatives thereof. Among these, imidazole, triazole, oxazole, thiazole, indole, benzimidazole, benzotriazole, benzoxazole and benzothiazole are preferable, and imidazole, triazole, benzimidazole and benzotriazole are more preferable.

The nitrogen-containing non-aromatic compound that can be used in the invention includes, for example, pyrrolidine, piperidine, piperazine, morpholine, decarhydroquinoline, decahydroisoquinoline, indoline, isoindoline, pyrrolizidine, quinolizidine, quinuclidine and 1,4-diazabicyclo[2,2,2]octane. Among these, pyrrolidine, piperidine, piperazine, morpholine, quinuclidine and 1,4-diazabicyclo[2,2,2]octane are preferable, and pyrrolidine, piperidine, morpholine and quinuclidine are more preferable.

In the atomic group forming a nitrogen-containing heterocyclic compound cation contained in the composition of the invention, a substituent group on a cation-forming nitrogen atom or another atom is not particularly limited, and the atomic group may have or may not have any substituent group.

Examples of such substituent group include an alkyl group, aryl group, heterocyclic group, halogen atom, alkoxy group, aryloxy group, alkylthio group, arylthio group, alkoxycarbonyl group, aryloxycarbonyl group, acyloxy group, acylamino group, carbamoyl group, sulfamoyl group, cyano group, hydroxyl group, nitro group, carboxyl group, mercapto group, sulfo group, acyl group and amino group.

The alkyl group represents a linear or cyclic alkyl group which may further have a substituent group, and is preferably an alkyl group containing 1 to 30 carbon atoms in total, more preferably an alkyl group containing 1 to 25 carbon atoms in total, still more preferably an alkyl group containing 1 to 20 carbon atoms. Preferable examples include a methyl group, ethyl group, n-propyl group, isopropyl group, n-butyl group, isobutyl group, tert-butyl group, n-hexyl group, n-octyl group, n-nonyl group, isononyl group, tert-nonyl group, cyclohexyl group, decyl group, dodecyl group, tetradecyl group, hexadecyl group, octadecyl group, 4-chlorobenzyl group, and (4-ethoxyphenyl) methyl group.

The aryl group may further have a substituent group, and is preferably an aryl group containing 6 to 30 carbon atoms in total, more preferably an aryl group containing 6 to 25 carbon atoms in total, still more preferably an aryl group containing 6 to 20 carbon atoms. Preferable examples include a phenyl group, 4-methylphenyl group, 2-methylphenyl group, 4-methoxyphenyl group, naphthyl group, anthracenyl group and phenanthryl group.

The heterocyclic group may further have a substituent group, may be a saturated or unsaturated heterocyclic group, and is preferably a 3- to 10-memberred heterocycle, more preferably a 4- to 8-memberred heterocycle, further more preferably a 5- to 7-memberred heterocycle. Preferable examples include an oxazole ring, thiazole ring, imidazole ring, pyrazole ring, triazole ring, isoxazole ring, isothiazole ring, furan ring, thiophene ring, pyrrole ring, pyridine ring, pyrimidine ring and triazine ring. In this case, however, the substituent group is not bound via a hetero-atom moiety. This heterocyclic group may be benzo-condensed.

The halogen atom is preferably a fluorine atom, chlorine atom, bromine atom or iodine atom, particularly preferably a fluorine atom or chlorine atom.

The alkoxy group may further have a substituent group, and is preferably an alkoxy group containing 1 to 30 carbon atoms in total, more preferably an alkoxy group containing 1 to 25 carbon atoms in total, still more preferably an alkoxy group containing 1 to 20 carbon atoms. Preferable examples include a methoxy group, ethoxy group, n-propyloxy group, isopropyloxy group, n-butyloxy group, tert-butyloxy group, n-hexyloxy group, n-octyloxy group, 2-ethylhexyloxy group, 3,5,5-trimethylhexyloxy group, n-decyloxy group, n-dodecyloxy group, n-tetradecyloxy group, n-hexadecyloxy group, n-octadecyloxy group, cyclohexyloxy group, benzyloxy group, α-methylbenzyloxy group, 4-vinylbenzyloxy group, 3-vinylbenzyloxy group, aryloxy group, 2-methoxyethoxy group and 2-ethoxyethoxy group.

The aryloxy group may further have a substituent group, and is preferably an aryloxy group containing 6 to 30 carbon atoms in total, more preferably an aryloxy group containing 6 to 25 carbon atoms in total, still more preferably an aryloxy group containing 6 to 20 carbon atoms. Preferable examples include a phenyloxy group, naphthyloxy group, anthracenyloxy group, pyrenyloxy group, 2-chlorophenyloxy group, 4-methoxyphenyloxy group, 4-phenoxyphenyloxy group, 4-dodecylthioxyphenyloxy group and 4-cyanophenyloxy group.

The alkylthio group may further have a substituent group, and is preferably an alkylthio group containing 1 to 30 carbon atoms in total, more preferably an alkylthio group containing 1 to 25 carbon atoms in total, still more preferably an alkylthio group containing 1 to 20 carbon atoms. Preferable examples include a methylthio group, ethylthio group, n-propylthio group, isopropylthio group, n-butylthio group, isobutylthio group, tert-butylthio group, n-hexylthio group, n-octylthio group, n-nonylthio group, n-decylthio group, n-dodecylthio group, n-tetradecylthio group, n-hexadecylthio group, n-octadecylthio group, isononylthio group, tert-nonylthio group, cyclohexylthio group and arylthio group.

The arylthio group may further have a substituent group, and is preferably an arylthio group containing 6 to 30 carbon atoms in total, more preferably an alkylthio group containing 6 to 25 carbon atoms in total, still more preferably an alkylthio group containing 6 to 20 carbon atoms. Preferable examples include a phenylthio group, naphthylthio group, anthracenylthio group, phenanthrylthio group, pyrenylthio group, perylenylthio group, 2-butoxyphenylthio group, 2-benzoylaminophenylthio group and 3-octyloxyphenylthio group.

The alkoxycarbonyl group may further have a substituent group, and is preferably an alkoxycarbonyl group containing 2 to 30 carbon atoms in total, more preferably an alkoxycarbonyl group containing 2 to 18 carbon atoms in total, still more preferably an alkoxycarbonyl group containing 2 to 16 carbon atoms in total. Preferable examples include a methyloxycarbonyl group, ethyloxycarbonyl group, butyloxycarbonyl group, 2-ethylhexyloxycarbonyl group, decyloxycarbonyl group, dodecyloxycarbonyl group and octadecyloxycarbonyl group.

The aryloxycarbonyl group may further have a substituent group, and is preferably an aryloxycarbonyl group containing 7 to 20 carbon atoms in total, more preferably an aryloxycarbonyl group containing 7 to 18 carbon atoms in total, still more preferably an aryloxycarbonyl group containing 7 to 16 carbon atoms in total. Preferable examples include a phenyloxycarbonyl group, naphthyloxycarbonyl group, anthracenyloxycarbonyl group and pyrenyloxycarbonyl group.

The acyloxy group may further have a substituent group and may be an aliphatic or aromatic acyloxy group. The acyloxy group is preferably an acyloxy group containing 2 to 30 carbon atoms in total, more preferably an acyloxy group containing 2 to 24 carbon atoms in total, still more preferably an acyloxy group containing 2 to 20 carbon atoms in total. Preferable examples include an acetyloxy group, propionyloxy group, n-octanoyloxy group, n-decanoyloxy group, benzoyloxy group, N-phenylacetyloxy group and N-methylacetyloxy group.

The acylamino group may further have a substituent group and may be an aliphatic or aromatic acylamino group. The acylamino group is preferably an acylamino group containing 2 to 30 carbon atoms in total, more preferably an acylamino group containing 2 to 24 carbon atoms in total, still more preferably an acylamino group containing 2 to 20 carbon atoms in total. Preferable examples include an acetylamino group, propionylamino group, n-octanoylamino group, n-decanoylamino group, n-dodecanoylamino group, n-tetradecanoylamino group, n-octadecanoylamino group, benzoylamino group, N-phenylacetylamino group and N-methylacetylamino group.

The carbamoyl group may further have a substituent group, and is preferably a carbamoyl group containing 1 to 30 carbon atoms in total, more preferably a carbamoyl group containing 1 to 25 carbon atoms in total, still more preferably a carbamoyl group containing 1 to 20 carbon atoms in total. Preferable examples include an ethylaminocarbonyl group, butylaminocarbonyl group, hexylaminocarbonyl group, octylaminocarbonyl group, dodecylaminocarbonyl group, octadecylaminocarbonyl group, diethylaminocarbonyl group, di-n-octylaminocarbonyl group, di-n-dodecylaminocarbonyl group, phenylarninocarbonyl group and benzylaminocarbonyl group.

The sulfamoyl group may further have a substituent group, and is preferably a sulfamoyl group containing 0 to 30 carbon atoms in total, and is preferably unsubstituted sulfamoyl, N,N-dimethylsulfamoyl group, N,N-diethylsulfamoyl group, N,N-dibutylsulfamoyl group, pyrrolidinosulfonyl group, piperidinosulfonyl group, morpholinosulfonyl group, N′-sulfonylpiperazinosulfonyl group or hexamethylene iminosulfonyl group. The sulfamoyl group is more preferably a sulfamoyl group containing 3 to 13 carbon atoms in total, and is particularly preferably N,N,-dimethylsulfamoyl group, N,N-diethylsulfamoyl group, N,N-di-n-butylsulfamoyl group, pyrrolidinosulfamoyl group or piperidinosulfamoyl group.

The acyl group may further have a substituent group, and is preferably an acyl group containing 2 to 20 carbon atoms in total, more preferably an acyl group containing 2 to 18 carbon atoms in total, still more preferably an acyl group containing 2 to 16 carbon atoms in total. Preferable examples include an acetyl group, propanoyl group, hexanoyl group, octanoyl group, decanoyl group, dodecanoyl group, tetradecanoyl group, hexadecanoyl group, octadecanoyl group or benzoyl group.

The atomic group forming a nitrogen-containing heterocyclic compound cation, represented by Y⁺ in formula (1), is preferably a group represented by the following formula (5):

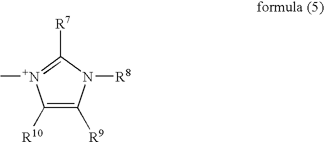

In formula (5), R⁷, R⁹ and R¹⁰ independently represent a hydrogen atom, a halogen atom, an alkyl group or an aryl group, and R⁸ represents an alkyl group and an aryl group.

The halogen atom represented by R⁷, R⁹ and R¹⁰ in formula (5) is preferably a fluorine atom, chlorine atom, bromine atom or iodine atom, particularly preferably a fluorine atom, chlorine atom or bromine atom.

The alkyl or aryl group represented by R⁷, R⁸, R⁹ and R¹⁰ in formula (5) has the same meaning as defined in R¹, R² and R³ in formula (3), and preferable examples thereof are also the same as defined therein. These groups may have a substituent group, and their substituent group has the same meaning as that of R¹, R² and R³, and preferable examples thereof are also the same as defined therein.

In formula (1), Z represents at least one kind of unit derived from a monomer having an ethylenic double bond.

Specific examples of the monomer include, for example, aromatic vinyls (for example, styrene, vinyl toluene, α-methyl styrene etc.), (meth)acrylates (for example, methyl (meth)acrylate, ethyl (meth)acrylate, propyl (meth)acrylate, isopropyl (meth)acrylate, n-butyl (meth)acrylate, i-butyl (meth)acrylate, t-butyl (meth)acrylate, hexyl (meth)acrylate, octyl (meth)acrylate, 2-ethylhexyl (meth)acrylate, dodecyl (meth)acrylate, stearyl (meth)acrylate, cyclohexyl (meth)acrylate, phenyl (meth)acrylate, benzyl (meth)acrylate, 2-hydroxyethyl (meth)acrylate etc.), (meth)acrylamides (for example, (meth)acrylamide, dimethyl (meth)acrylamide etc.), vinyl esters (vinyl acetate, vinyl propionate, vinyl versate etc.) and allyl esters (allyl acetate etc.). These monomers may be used alone or as a mixture of two or more thereof.

In formula (1), p is 1 to 30 mol %, preferably 1.5 to 25 mol %, still more preferably 2 to 20 mol %. q is 70 to 99 mol %, preferably 75 to 98.5 mol %, still more preferably 80 to 98 mol %.

The inorganic nature/organic nature ratio (I/O value) in an organic conceptual view of the above-mentioned Z in the above formula (1) is preferably less than 0.8. The I/O value is a parameter indicative of the degree of hydrophilicity/lipophilicity of compounds or substituent groups, and is detailed in Organic Conceptual View (in Japanese) (authored by Yoshio Koda and published in 1984 by Sankyo Shuppan), the disclosure of which is incorporated by reference herein.

I indicates inorganic nature, while O indicates organic nature, and a higher I/O value indicates higher inorganic nature (higher polarity and hydrophilicity).

In formula (1), Z is preferably a polymer (including a homopolymer or copolymer) formed from at least one kind of monomer selected from the group consisting of alkyl (meth)acrylates, styrene and derivatives thereof. Preferable examples include styrene, vinyl toluene, n-butyl (meth)acrylate, t-butyl (meth)acrylate, hexyl (meth)acrylate, octyl (meth)acrylate and 2-ethylhexyl (meth)acrylate. These monomers may be used alone or as a mixture of two or more thereof.

The molecular weight of the polymer represented by formula (1) is preferably about 500 to 200,000, more preferably 1,000 to 100,000, in terms of weight-average molecular weight. When the molecular weight is less than 500, the organizing effect may be insufficient and the distance between sheets of the layered silicate may not be sufficiently large. When the molecular weight is 200,000 or more, handling suitability may be insufficient.

The cationic compound used in the invention is preferably a compound represented by the following formula (2): 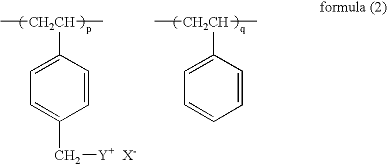
wherein X⁻ represents an anion; Y⁺ represents one group of atoms forming an ammonium cation, a phosphonium cation, or a nitrogen-containing heterocyclic compound cation; p is 1 to 30 mol %; and q is 70 to 99 mol %.

Preferable examples of X⁻, Y⁺, p and q in formula (2) are the same as described in the case of formula (1) above.

Preferable examples of the cationic compound used in the invention are shown below, but are not intended to limit the scope of the invention. Two or more of the compounds of formula (1) or (2) may be simultaneously used.

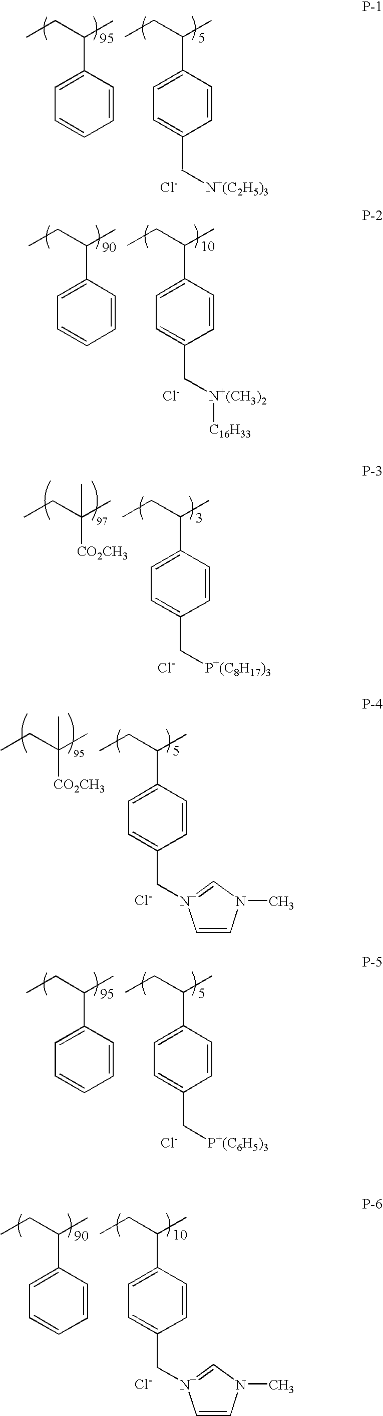

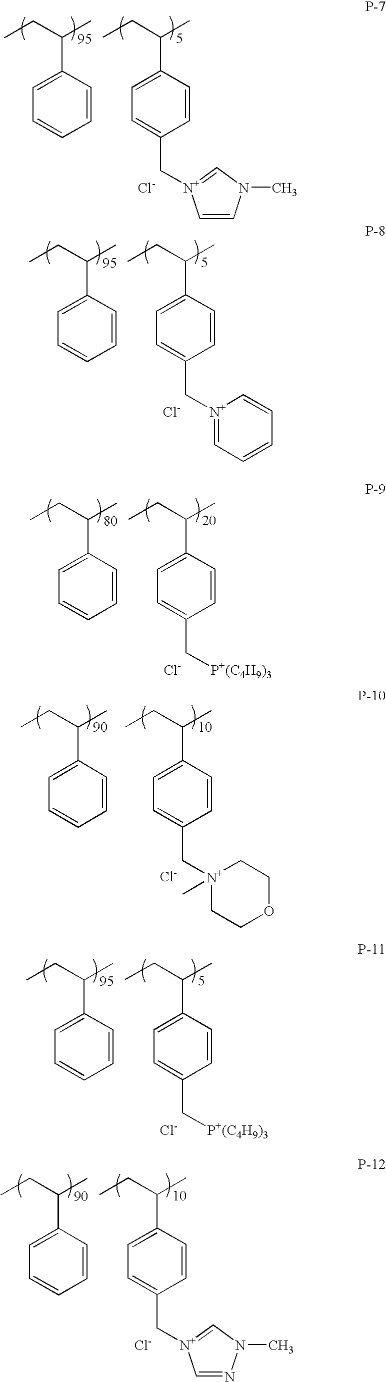

Their precursors, that is, a styrene/chloromethyl styrene copolymer, a methyl methacrylate/chloromethyl styrene copolymer etc. can be synthesized according to methods described in Polymer Degradation and Stability 83 (2004), pp. 333-346. As will be shown in the Examples, the polymer can also be synthesized by a method of radical copolymerization of styrene with chloromethyl styrene. A polymer wherein methyl methacrylate or another vinyl monomer is radical-copolymerized with chloromethyl styrene and a polymer wherein the ratio of the monomers is changed can also be obtained by similar methods.

The cationic compound of the invention can be obtained by reacting the above copolymer with a commercial phosphine derivative, an amine derivative and a nitrogen-containing heterocyclic derivative.

Alternatively, the cationic compound can be synthesized by reacting chloromethyl styrene with a commercial phosphine derivative, an amine derivative and a nitrogen-containing heterocyclic derivative to synthesize a cation monomer and then radical-copolymerizing it with styrene and methyl methacrylate.

(Swellable Layered Silicate)

The swellable layered silicate used in the invention is not particularly limited and can be selected as necessary from known swellable layered silicates. The swellable layered silicate includes, for example, smectite group clay minerals such as naturally occurring or synthetic hectorite, saponite, stevensite, beidellite, montmorilonite, nontronite and bentonite, swellable mica group clay minerals such as Na-type tetrasilicic fluorine mica, Li-type tetrasilicic fluorine mica, Na-type fluorine taeniolite and Li-type fluorine taeniolite, and vermiculite or a mixture of two or more thereof.

The swellable layered silicate is preferably at least one member selected from synthetic hectorite, naturally occurring hectorite, naturally occurring montmorilonite, synthetic smectite and synthetic mica.

The layered silicate includes commercial products such as Laponite XLG (synthetic compound similar to hectorite, manufactured by Laporte Co., UK), Laponite RD (synthetic compound similar to hectorite, manufactured by Laporte Co., UK), Thermovis (synthetic compound similar to hectorite, manufactured by Henkel Co., Germany), Smecton SA-1 (compound similar to saponite, manufactured by Kunimine Industries Co., Ltd.), Bengel (naturally occurring montmorilonite, manufactured by Hojun Yoko K.K.), Kunipia F (naturally occurring montmorilonite, manufactured by Kunimine Industries Co., Ltd.), Biegum (naturally occurring hectorite, manufactured by Binderbilt Co., US), Dimonite (synthetic swellable mica manufactured by Topy Industries, Ltd.), Somasif (synthetic swellable mica, manufactured by Co-op Chemical Co., Ltd.), SWN (synthetic smectite, manufactured by Co-op Chemical Co., Ltd.) and SWF (synthetic smectite, manufactured by Co-op Chemical Co., Ltd.).

The “swellable” means to have properties to swell when a solvent such as water, alcohol, or ether permeates through crystalline layers of the layered silicates.

In the polyester resin composition of the invention, the swellable layered silicate is contained in an organized state organized by an organizing agent. The interlaminar inorganic ions of the layered silicate as the inorganic component in the invention can be replaced by organic ions to increase compatibility with resin components constituting the matrix.

In the invention, a method of organizing the swellable layered silicate is not particularly limited and any known methods may be used insofar as at least a cation of the cationic compound represented by formula (1) is contained among the sheets.

As one example, there is a method of organizing the swellable layered silicate by dispersing it in a solvent and then mixing it with the cationic compound represented by the formula (1), followed by ion-exchanging a part or all cations (Na, Li etc.) present between crystal layers of the silicate, with cations of the cationic compound, and the process for producing the same is not particularly limited. In this case, the solvent includes water, methanol, ethanol, propanol, isopropanol, ethylene glycol, 1,4-butanediol, acetone, tetrahydrofuran, 1,4-dioxane and a mixed solvent thereof, among which water, methanol, ethanol, acetone and tetrahydrofuran are preferable, and water, ethanol, acetone and tetrahydrofuran are particularly preferable.

The dispersing machine used can be suitably selected from generally used dispersing machines, and for example, stirring machines such as a magnetic stirrer, a three-one motor etc. are used.

The drying is carried out generally at a temperature of 25 to 150° C., more preferably 30 to 120° C., still more preferably 40 to 110° C. The drying time varies depending on the temperature and may be suitably selected, and is generally 4 to 72 hours, more preferably 8 to 48 hours, still more preferably 12 to 36 hours. The drying may be carried out at normal pressures or under reduced pressure and specifically the drying is carried out preferably at 0.01 to 760 Torr (about 1.33 Pa to 1013 hPa), more preferably 0.01 to 50 Torr, still more preferably 0.01 to 1 Torr.

Though being not particularly limited, the silicate is dried until the amount of the solvent in the silicate is reduced preferably to 20% by mass or less, more preferably 0.1 to 5% by mass, further more preferably 0.1 to 2% by mass, from the viewpoint of handling, dispersing upon kneading with polyester, and foaming.

According to the method described above, the swellable layered silicate is organized by ion-exchange between a part or all of cations (for example, Na, Li etc.) present between crystal layers of the swellable layered silicate and organic cations of the organizing agent.

The content of the cationic compound having cations to be contained among sheets of the swellable layered silicate is not particularly limited with respect to the swellable layered silicate, but is preferably 1.0 to 10.0 times, more preferably 1.1 to 5.0 times and still more preferably 1.2 to 3.0 times the clay cation exchange capacity (CEC, meq/100 g).

(Thermoplastic Polyester Resin)

The thermoplastic polyester resin used in the invention is a linear or branched polyester compound having fluidity upon heating, and is obtained usually by polycondensation of a divalent carboxylic acid compound with a divalent alcohol.

The divalent carboxylic acid component may be an aromatic dicarboxylic acid or an aliphatic or another dicarboxylic acid, and specific examples include one or more bifunctional carboxylic acids such as oxalic acid, succinic acid, adipic acid, sebacic acid, dimer acid, hexahydroterephthalic acid, phthalic acid, isophthalic acid, terephthalic acid, 2,6-naphthalenedicarboxylic acid, 2,7-naphthalenedicarboxylic acid, 1,5-naphthalenedicarboxylic acid, diphenyldicarboxylic acid, diphenyl ether dicarboxylic acid, diphenoxyethane-4,4-dicarboxylic acid, diphenylsulfonedicarboxylic acid, glycolic acid, 2-chloroterephthalic acid, 5-methylisophthalic acid, 5-sodiumsulfoisophthalic acid and 1,4-cyclohexanedicarboxylic acid.

In actual condensation polymerization, a polycondensate may be obtained by a method of polycondensation of the divalent carboxylic acid by removing alcohol by esterification with methyl alcohol, or by using a divalent carboxylic anhydride. In this case, the divalent carboxylic acid component is an ester or acid anhydride of the above-mentioned dicarboxylic acid.

The divalent alcohol component may be an aromatic dialcohol or an aliphatic or another dialcohol, and specific examples include one or more bifunctional alcohols such as ethylene glycol, polyethylene glycol represented by HO(CH₂)ₙOH (n is an integer of 3 to 10), isobutylene glycol, 1,4-cyclohexane dimethanol, neopentyl glycol, 1,4-cyclohexane diol, 2,2-bis-4-hydroxyphenyl propane, hydroquinone, 1,5-dihydroxy naphthalene, 2,6-dihydroxy naphthalene, and 1,4-bis(β-hydroxyethoxy)benzene.

The thermoplastic polyester resin obtained above is preferably polyethylene terephthalate, polybutylene terephthalate or polyethylene naphthalate, more preferably polyethylene terephthalate or polyethylene naphthalate, further more preferably polyethylene terephthalate.

The content of the organized swellable layered silicate (organic modified layered silicate) in the polyethylene resin composition of the invention is preferably 0.5 to 30% by mass, more preferably 3 to 20% by mass, relative to the total solid mass of the polyester resin composition. When the amount of the swellable layered silicate incorporated is less than 0.5% by mass, the reinforcing effect of the introduced layered silicate may not be sufficiently obtained, while when the amount is higher than 30% by mass, the dispersibility and transparency of the inorganic filler such as layered silicate may be deteriorated, and the physical strength of a molded product, film etc. produced from the polyester resin composition may be deteriorated to make them brittle.

(Kneading and Dispersing)

The polyester resin composition of the invention can be produced easily by kneading the respective materials in a molten state, and the kneading procedure and a means used for kneading are not particularly limited. The mixing kneading machine used in melt kneading is not particularly limited, and examples include a twin-screw extruder, a twin-screw rotor continuous kneader, a mortar continuous kneader (KCK) for kneading between a rotating disk and a stationary disk, a Banbury mixer, a kneader, a roll mill etc.

The polyester resin composition of the invention can be used widely in various applications such as various molded products, films for optical materials, substrates for magnetic materials, and substrates for image-forming layers.

### EXAMPLES

Hereinafter, the invention is described in more detail by reference to the Examples, but the invention is not limited to these examples. The term “parts” in the Examples refers to “parts by mass” unless otherwise specified.

### Synthesis Example 1

(Synthesis of Cationic Compound)

104.2 g of styrene, 7.3 g of chloromethylstyrene (CMS-14, manufactured by Seimi Chemical) and 4 g 2-mercaptoethanol are dissolved in 45 g of ethanol and then heated at 70° C. in a nitrogen stream, followed by adding 0.63 g of 2,2′-azobis(2,4-dimethyl valeronitrile) (V-65, manufactured by Wako Pure Chemical Industries, Ltd.) and stirring under heating at 70° C. After 3 hours, 0.63 g of 2,2′-azobis(2,4-dimethyl valeronitrile) (V-65, manufactured by Wako Pure Chemical Industries, Ltd.) is further added thereto and stirred for 3 hours under heating at 70° C. This reaction solution is poured into 5 L of methanol under stirring, and the resulting solid is filtered and dried to give a white solid of a styrene/chloromethylstyrene copolymer as a precursor of the cationic compound of the invention.

20 g of the white solid and 2 g of triethylamine are dissolved in 40 mL of tetrahydrofuran and heated under reflux for 24 hours. This reaction solution is poured into 1 L of n-hexane under stirring, and the resulting viscous solid is dried to give 19 g of white solid of exemplary compound P-1.

### Synthesis Example 2

A white solid of a copolymer as the precursor is synthesized in the same manner as in Synthesis Example 1 except that in place of styrene and chloromethylstyrene, methyl methacrylate and chloromethylstyrene are used in a molar ratio of 95:5.

20 g of this white solid and 1.6 g of N-methylimidazole are reacted and treated in the same manner as in Synthesis Example 1, whereby 18 g of white solid of exemplary compound P-4 is obtained.

### Synthesis Example 3

7 g of chloromethylstyrene and 4 g of N-methylimidazole are dissolved in 25 mL ethanol, and 0.1 g of hydroquinone monomethyl ether is added thereto and stirred at 70° C. for 4 hours. This solution is left and cooled to room temperature, and then 52 g of styrene and 2.2 g of 2-mercaptoethanol are added thereto and heated at 70° C. in a nitrogen stream, followed by adding 0.11 g of 2,2′-azobis(2,4-dimethyl valeronitrile) (V-65, manufactured by Wako Pure Chemical Industries, Ltd.) and stirring under heating at 70° C. After 3 hours, 0.11 g of 2,2′-azobis(2,4-dimethyl valeronitrile) (V-65, manufactured by Wako Pure Chemical Industries, Ltd.) is further added thereto and stirred for 3 hours under heating at 70° C. This reaction solution is poured into 2 L of n-hexane under stirring, and the resulting solid is filtered and dried to give 45 g of white solid of exemplary compound P-6.

### Synthesis Example 4

20 g of the copolymer as a precursor synthesized in Synthesis Example 1 and 1.6 g of N-methylimidazole (Wako Pure Chemical Industries, Ltd.) are reacted and treated in the same manner as in Synthesis Example 1, whereby 20 g of white solid of exemplary compound P-7 is obtained.

### Synthesis Example 5

A copolymer as the precursor is synthesized in the same manner as in Synthesis Example 1 except that styrene and chloromethylstyrene are used in a molar ratio of 90:10.

20 g of this white solid and 2 g of N-methyl morpholine are reacted and treated in the same manner as in Synthesis Example 1, whereby 18 g of white solid of exemplary compound P-10 is obtained.

### Synthesis Example 6

20 g of the copolymer as a precursor synthesized in Synthesis Example 1 and 4 g of tributyl phosphine (Tokyo Kasei) are reacted and treated in the same manner as in Synthesis Example 1, whereby 23 g of white solid of exemplary compound P-11 is obtained.

### Example 1

(Preparation of Organic Modified Layered Silicate)

4 g of Somasif ME-100 (synthetic mica) manufactured by Co-op Chemical Co., Ltd. is obtained as the swellable layered silicate, then dispersed in 400 mL of mixed solvent of water and tetrahydrofuran, mixed under stirring with 8 g of the above compound (P-1), filtered under suction with a Buchner funnel, and dried at a pressure of 1 Torr at 110° C. for 12 hours to give an organic modified layered silicate (1).

(Preparation of Polyester Resin Composition)

A polyethylene terephthalate (PET) having an intrinsic viscosity of 0.65 is used as thermoplastic polyester resin, and 2.5 parts of the organized layered silicate (1) obtained above and 0.25 parts each of Irgafos 168 and Irganox 1010 (manufactured by Ciba Geigy Ltd.) as antioxidants are incorporated into 50 parts of the polyester resin and introduced into a twin-screw extruder TEM-37 manufactured by Toshiba Machine Co., Ltd., to give the polyester resin composition of the invention. The above melting and kneading are carried out at a temperature of 280° C., at a screw revolution number of 500 rpm and an throughput rate of 10 kg/h.

The polyester resin composition is prepared such that the content of the organic modified layered silicate became 5% by mass.

[Evaluation Test]

(Measurement of the Distance Between Sheets of the Organic Modified Layered Silicate and the Heat Weight Loss Thereof)

The organic modified layered silicate (1) organized with the compound (P-1) obtained above is measured for X-ray diffraction in the range of 2θ=2 to 30° by the θ-2θ method by using Geiger Flex RAD-rA (manufactured by RIGAKU) with CuKα light as a light source thereby determining the distance between the sheets.

Further, the loss in weight by heating of the organic modified layered silicate (1) when heated at room temperature (25° C.) to 275° C. at a rate of 10° C./min. in a nitrogen atmosphere is measured by TGA-50 manufactured by Shimadzu Corporation. The results are shown in Table 1.

(Evaluation of the Polyester Resin Composition)

The polyester resin compositions of the invention obtained above are examined in the following evaluation tests. The results are shown in Table 2 below.

(1) Evaluation of State of Dispersion

The diffraction peak of a (001) plane of the organic modified layered silicate (1) is measured by wide-angle X-ray diffraction (machine type, RAD-C Rota Flex, manufactured by Rigaku Denki) and simultaneously the state of dispersion is observed under a transmission electron microscope (machine type, JEM2010, manufactured by JEOL Ltd.). On the basis of theses measurements and observation results, the state of dispersion is evaluated under the following criteria.
G1: No diffraction peak is existed, and recognized aggregated particles are 10% or less.
G2: No diffraction peak is existed, and recognized aggregated particles are less than 30%.
G3: Diffraction peak is existed, and recognized aggregated particles are 30% or more.
   (2) Tensile Modulus of Elasticity

A specimen with thickness 1 mm×width 10 mm prepared from the polyester resin composition by hot press is examined by a tensile testing machine (machine type, STROGRAPH VE5D, manufactured by Toyo Seiki Seisaku-sho, Ltd.). On the basis of the result, the modulus of elasticity is determined and the improvement ratio (%) of the modulus of elasticity of each polymer resin composition compared with the modulus of elasticity of the test specimen of the corresponding “non-reinforced resin” composition is used as an index of evaluation. The evaluation criteria are as shown below.
G0: The improvement ratio relative to the non-reinforced resin specimen is 100% or more.
G1: The improvement ratio relative to the non-reinforced resin specimen is 50 to 100%.
G2: The improvement ratio relative to the non-reinforced resin specimen is 20 to 50%.
G3: The improvement ratio relative to the non-reinforced resin specimen is less than 20%, or the modulus of elasticity is decreased without improvement.

As used herein, the “non-reinforced resin” composition refers to a layered silicate-free composition obtained by the same operation using polyethylene terephthalate (PET) only.

(3) Transparency

A sheet of 0.5 mm in thickness is prepared from each polyester resin composition and measured for light transmittance with a turbidity meter NDH-1001DP manufactured by Nihon Denshoku Industries Co., Ltd. and the ratio (%) of each light transmittance to the light transmittance of the test specimen of the corresponding “non-reinforced resin” composition is used as an index of evaluation. The evaluation criteria are as follows:
G0: 95% or more relative to the non-reinforced resin sheet.
G1: 90 to 95% relative to the non-reinforced resin sheet.
G3: 70 to 90% relative to the non-reinforced resin sheet.
G4: Less than 70% relative to the non-reinforced resin sheet.

### Examples 2 to 6

The organic modified silicates and polyester resin compositions of the invention are prepared in the same manner as in Example 1 except that in place of 8 g of compound (P-1) as the organizing agent, 8 g of (P-4), 4 g of (P-6), 8 g of (P-7), 4 g of (P-10) and 8 g of (P-11) are used respectively in “Preparation of organic modified layered silicate” in Example 1. The same evaluation as in Example 1 is carried out, and the results are shown in Tables 1 and 2.

### Example 7

An organic modified swellable layered silicate and a polyester resin composition are prepared in the same manner as in Example 1 except that in place of 4 g of Somasif ME-100 (synthetic mica), SWN (synthetic smectite, manufactured by Co-op Chemical Co., Ltd.) is used in the preparation of the swellable layered silicate in Example 1. The same evaluation as in Example 1 is carried out, and the results are shown in Tables 1 and 2.

### Comparative Example 1

A polyester resin composition is prepared in the same manner as in Example 1 except that Somasif ME-100 (synthetic mica, manufactured by Co-op Chemical Co., Ltd.) is used without modification by organization as the swellable layered silicate in the preparation of the polyester resin composition in Example 1. The same evaluation as in Example 1 is carried out, and the results are shown in Tables 1 and 2.

### Comparative Example 2

An organic modified layered silicate and a polyester resin composition are prepared in the same manner as in Example 1 except that in place of the compound (P-1), the tetraalkyl ammonium salt (B-1) shown below is used in “Preparation of organic modified layered silicate” in Example 1. The same evaluation as in Example 1 is carried out, and the results are shown in Tables 1 and 2.

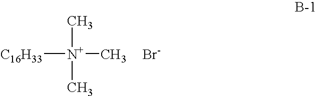

TABLE 1

| | Organizing | Distance between |
|---|---|---|
| | agent | the sheets (Å) |
| Example 1 | P-1 | 18.8 |
| Example 2 | P-4 | 16.6 |
| Example 3 | P-6 | 22.2 |
| Example 4 | P-7 | 25.3 |
| Example 5 | P-10 | 19.9 |
| Example 6 | P-11 | 22.2 |
| Example 7 | P-1 | 14.4 |
| Comparative Example 1 | none | 9.6 |
| Comparative Example 2 | B-1 | 20.3 |

As can be seen from Table 1, the distance between the sheets of the organic modified layered silicates in Examples 1 to 6, as compared with the non-organized layered silicate in Comparative Example 1, extend in the range of 7 to 15 Å. It is thus found that the cationic compound can be intercalated (inserted) into among the sheets of the organic modified layered silicate in the invention to the same degree as the tetraalkyl ammonium salt.

TABLE 2

| Resin | Organizing | State of | Tensile modulus | Trans- |
|---|---|---|---|---|
| composition | agent | dispersion | of elasticity | parency |
| Example 1 | P-1 | G1 | G1 | G1 |
| Example 2 | P-4 | G1 | G1 | G1 |
| Example 3 | P-6 | G1 | G0 | G0 |
| Example 4 | P-7 | G1 | G0 | G0 |
| Example 5 | P-10 | G1 | G1 | G1 |
| Example 6 | P-11 | G1 | G0 | G0 |
| Example 7 | P-1 | G1 | G1 | G1 |
| Comparative | none | G3 | G2 | G2 |
| Example 1 | | | | |
| Comparative | B-1 | G1 | G2 | G1 |
| Example 2 | | | | |

As shown in Table 2 above, the Comparative Examples did not satisfy all evaluations. On the other hand, the polyester resin compositions (Examples 1 to 6) in the invention are excellent in an ability to disperse the organic modified layered silicate and improve tensile modulus of elasticity (mechanical strength). These compositions are also found to be excellent in transparency.

According to an aspect of the invention, there can be provided a polyester resin composition which is constituted by dispersing a layered silicate filler of nano-order uniformly at a high degree, has particularly high strength and high heat resistance, and also has high transparency with low haze and dimensional stability.

All publications, patent applications, and technical standards mentioned in this specification are herein incorporated by reference to the same extent as if each individual publication, patent application, or technical standard was specifically and individually indicated to be incorporated by reference.

1. A polyester resin composition comprising an organic modified layered silicate and a thermoplastic polyester resin, wherein the organic modified layered silicate contains between layers of a swellable layered silicate at least a cation of a cationic compound represented by the following formula (1): 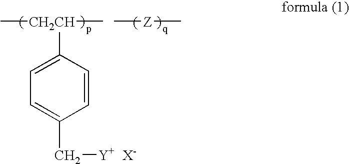
wherein X⁻ represents an anion; Y⁺ represents one groups of atoms forming an ammonium cation, a phosphonium cation, or a nitrogen-containing heterocyclic compound cation; Z is at least one kind of unit derived from a monomer having an ethylenic double bond; p is 1 to 30 mol %; and q is 70 to 99 mol %.

2. The polyester resin composition of claim 1, wherein an inorganic nature/organic nature ratio (I/O value) in an organic conceptual view of Z in formula (1) is less than 0.8.

3. The polyester resin composition of claim 1, wherein the Z in formula (1) is a polymer formed from at least one kind of monomer selected from the group consisting of alkyl (meth)acrylates, styrene and derivatives thereof.

4. The polyester resin composition of claim 1, wherein formula (1) is also represented by the following formula (2): 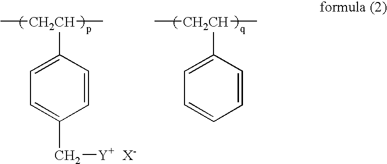
wherein X⁻ represents an anion; Y⁺ represents one group of atoms forming an ammonium cation, a phosphonium cation, or a nitrogen-containing heterocyclic compound cation; p is 1 to 30 mol %; and q is 70 to 99 mol %.

5. The polyester resin composition of claim 1, wherein Y⁺ in formula (1) is a cation represented by one of the following formulae (3) to (5): 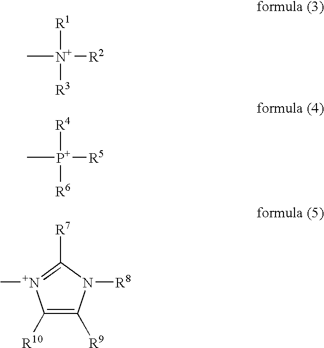
wherein R¹, R² and R³ independently represent a hydrogen atom, an alkyl group or an aryl group; R⁴, R⁵ and R⁶ independently represent an alkyl group or an aryl group; R⁷, R⁹ and R¹⁰ independently represent a hydrogen atom, a halogen atom, an alkyl group or an aryl group; and R⁸ represents an alkyl group or an aryl group.

6. The polyester resin composition of claim 1, wherein the swellable layered silicate is one of a synthetic hectorite, naturally occurring hectorite, naturally occurring montmorillonite, synthetic smectite or synthetic mica.

7. The polyester resin composition of claim 1, wherein the content of the organic modified layered silicate is 0.5 to 30% by mass.

8. The polyester resin composition of claim 1, wherein the thermoplastic polyester resin is polyethylene terephthalate.

9. The polyester resin composition of claim 1, wherein the amount of the cationic compound contained between layers of the swellable layered silicate is 1.0 to 10.0 times the cation exchange capacity (CEC, meq/100 g) of the swellable layered silicate.

10. The polyester resin composition of claim 2, wherein the Z in formula (1) is a polymer formed from at least one kind of monomer selected from the group consisting of alkyl (meth)acrylates, styrene and derivatives thereof.

11. The polyester resin composition of claim 2, wherein formula (1) is also represented by the following formula (2): 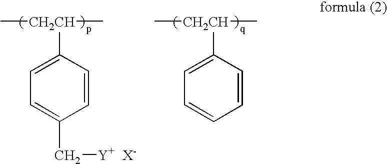
wherein X⁻ represents an anion; Y⁺ represents one group of atoms forming an ammonium cation, a phosphonium cation, or a nitrogen-containing heterocyclic compound cation; p is 1 to 30 mol %; and q is 70 to 99 mol %.

12. The polyester resin composition of claim 2, wherein Y⁺ in formula (1) is a cation represented by one of the following formulae (3) to (5): 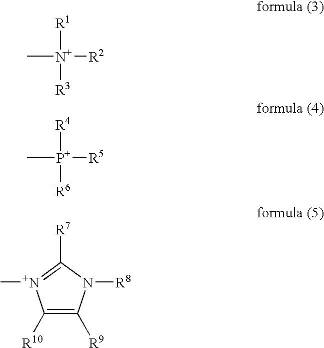
wherein R¹, R² and R³ independently represent a hydrogen atom, an alkyl group or an aryl group; R⁴, R⁵ and R⁶ independently represent an alkyl group or an aryl group; R⁷, R⁹ and R¹⁰ independently represent a hydrogen atom, a halogen atom, an alkyl group or an aryl group; and R⁸ represents an alkyl group or an aryl group.

13. The polyester resin composition of claim 2, wherein the swellable layered silicate is one of a synthetic hectorite, naturally occurring hectorite, naturally occurring montmorillonite, synthetic smectite or synthetic mica.

14. The polyester resin composition of claim 2, wherein the content of the organic modified layered silicate is 0.5 to 30% by mass.

15. The polyester resin composition of claim 2, wherein the thermoplastic polyester resin is polyethylene terephthalate.

16. The polyester resin composition of claim 2, wherein the amount of the cationic compound contained between layers of the swellable layered silicate is 1.0 to 10.0 times the cation exchange capacity (CEC, meq/100 g) of the swellable layered silicate.
